(19) United States
(12) Patent Application Publication
(10) Pub. No.: US 2019/0016008 A1
(43) Pub. Date: Jan. 17, 2019

(54) METHOD FOR COATING WOOD-BASED MATERIALS WITHOUT ABRADING THE SURFACE

(71) Applicant: BASF SE, Ludwigshafen am Rhein (DE)

(72) Inventors: RALPH LUNKWITZ, Neustadt (DE); Jens ASSMANN, Neustadt (DE); Michael FINKENAUER, Schneckenhausen (DE)

(21) Appl. No.: 15/750,623

(22) PCT Filed: Jul. 15, 2016
(86) PCT No.: PCT/EP2016/066881

§ 371 Date: Feb. 6, 2018

(30) Foreign Application Priority Data
Aug. 7, 2015 (DE) 10 215 215 096.8

(51) Int. Cl. B27K 3/36; B27K 3/15; B32B 21/06

(52) U.S. Cl. CPC B27K 3/36; B27K 3/153; B32B 21/06; B27K 2200/30; B32B 2451/00; B32B 2260/028; B32B 2260/046; B32B 2479/00; B32B 2260/026

(57) ABSTRACT

The present invention relates to a new and improved method for coating wood-based materials, which comprises treating the surface of a wood-based material with 0.05 to 50 g/m², preferably 0.1 to 20 g/m², more preferably 0.3 to 10 g/m² of a surface-active substance, preferably as 0.1 to 60 wt %, preferably 0.5 to 50 wt %, more preferably 1 to 40 wt %, more particularly 2.5 to 30 wt % solutions, more particularly a solution of a surfactant.

The present invention relates to a method for producing wood-based materials having a smooth surface by applying surfactants to the surface.

Methods for producing single-layer and multilayer wood-based materials are known in principle and described for example in M. Dunky, P. Niemz, Holzwerkstoffe and Leime, Springer 2002, pages 91 to 150. A firm component of the production operation is the inconvenient and costly sanding of the wood-based material immediately after the hot press. According to page 129, paragraph 3, the purpose of sanding is to remove the press skin. The press skin, which is attributable to the plastication of the wood in the hot press, has to be removed by sanding, again, because it seals the wood-based material in such a way as to prevent direct coating with decorative papers.

The coating of wood-based materials with decorative papers is typically accomplished using decorative papers impregnated with amino resin. A distinction is to be drawn here between decorative papers impregnated with melamine resin, and decorative papers containing urea resin.

Melamine-resin-impregnated decorative papers are heated together with the wood-based material board in the hot press under pressure (up to 60 bar) to around 200° C. In order to produce a durable bond between board and paper, the sanding of the wood-based material board is necessary.

Urea-resin-impregnated decorative papers are typically applied to a wood-based material board with the aid of what is called a curative primer and what is called a surface glue or laminating glue. Here again, in order to produce a durable bond between board and paper, the sanding of the wood-based material board is necessary.

The sanding of wood-based material boards is a component operation which consumes time and materials and is liable for improvement.

It was an object of the present invention, therefore, to remedy the disadvantages identified above, and in particular to develop a simpler and cost-effective technique allowing wood-based materials to be coated with decorative papers.

Found accordingly has been a new and improved method for coating wood-based material, which comprises treating the surface of a wood-based material with 0.05 to 50 g/m², preferably 0.1 to 20 g/m², more preferably 0.3 to 10 g/m² of a surface-active substance, preferably as 0.1 to 60 wt %, preferably 0.5 to 50 wt %, more preferably 1 to 40 wt %, more particularly 2.5 to 30 wt % solutions, more particularly a solution of a surfactant. The coating according to the invention is carried out preferably in place of, in other words without, partial abrading of the wood-based materials. The present invention further relates to coated wood-based materials produced according to the aforesaid method.

Suitable surfactants are anionic, cationic, nonionic, amphoteric surfactants or mixtures thereof.

Suitable anionic surfactants are
alkali metal, alkaline earth metal or ammonium sulfates such as ammonium sulfate, lithium sulfate, sodium sulfate, potassium sulfate, calcium sulfate, magnesium sulfate, strontium sulfate, lithium hydrogensulfate, sodium hydrogensulfate, potassium hydrogensulfate, calcium hydrogensulfate, magnesium hydrogensulfate, strontium hydrogensulfate, preferably sodium sulfate, potassium sulfate, calcium sulfate, magnesium sulfate, sodium hydrogensulfate, potassium hydrogensulfate, calcium hydrogensulfate, magnesium hydrogensulfate, preferably sodium sulfate, potassium sulfate, calcium sulfate and magnesium sulfate, more particularly sodium sulfate and ammonium sulfate,
sulfates of branched or unbranched fatty alcohols or oxo-process alcohols, branched or unbranched fatty alcohol alkoxylates or oxo-process alcohol alkoxylates,
fatty alcohol ether sulfates having branched or unbranched C₈-C₂₀ alkyl chains and 2 to 50 ethylene oxide (EO) units, preferably fatty alcohol ether sulfates having a C₈-C₁₄ alkyl chain and 2 to 12 ethylene oxide units,
sulfates of fatty acids and oils,
ethoxylated alkylphenol sulfates,
alcohol sulfates,
sulfates of ethoxylated alcohols or fatty acid esters,
sulfates of naphthyl alcohol or ethoxylated naphthyl alcohol,
sulfates of arylalkyl alcohols or arylalkyl ethoxylates,
alkali metal, alkaline earth metal or ammonium sulfonates such as alkylarylsulfonates, diphenylsulfonates, α-olefinsulfonates, lignosulfonates, sulfonates of fatty acids and oils, sulfonates of ethoxylated alkylphenols, sulfonates of alkoxylated arylphenols, naphthalenesulfonate condensates, dodecyl- and tridecylbenzenesulfonates, naphthalene- and sikylnaphthalenesulfonates or sulfosuccinates,
sulfonates of branched or unbranched fatty alcohols or oxo-process alcohols,
sulfonates of branched or unbranched fatty alcohol alkoxylates or oxo-process alcohol alkoxylates,
sulfonates of fatty acids and oils,
ethoxylated alkylphenol sulfonates,
alcohol sulfonates,
sulfonates of ethoxylated alcohols or fatty acid esters,
sulfonates of naphthyl alcohol or ethoxylated naphthyl alcohol,
sulfonates of arylalkyl alcohols or arylalkyl ethoxylates,
phosphates of branched or unbranched fatty alcohols or oxo-process alcohols,
phosphates of branched or unbranched fatty alcohol alkoxylates or oxo-process alcohol alkoxylates,
phosphates of fatty acids and oils,
ethoxylated alkylphenol phosphates,
alcohol phosphates,
phosphates of ethoxylated alcohols or fatty acid esters,
phosphates of naphthyl alcohol or ethoxylated naphthyl alcohol,
phosphates of arylalkyl alcohols or arylalkyl ethoxylates.

Suitable nonionic surfactants are
alkoxylates such as alcohols, alkylphenols, amines, amides, arylphenols, fatty acids or fatty acid esters which alkoxylated with 1 to 50 equivalents of alkylene oxide such as ethylene oxide and/or propylene oxide, preferably ethylene oxide,
N-substituted fatty acid amides such as fatty acid glucamides or fatty acid alkanolamides,
amine oxides,
esters such as fatty acid esters, glycerol esters or monoglycerides,
sugar-based surfactants such as sorbitan, ethoxylated sorbitans, sucrose esters, glycose esters or alkylpolyglucosides,
polymeric surfactants such as homo- or copolymer of vinylpyrrolidone, vinyl alcohols or vinyl acetates,
block polymers such as block polymers of A-B or A-B-A type containing blocks of polyethylene oxide and polypropylene oxide, or of A-B—C type containing alkanol and blocks of polyethylene oxide and polypropylene oxide.

The nonionic surfactants may be alkyl alcohol alkoxylates with an unbranched or branched, primary or secondary alkyl chain, or aryl alkoxylates. Preferred are alkyl or aryl alkoxylates of the formula (I)

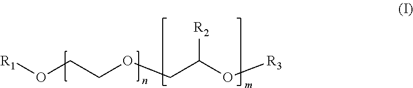

where
R₁=linear or branched, primary or secondary C₇ to C₂₄ alkylphenyl and naphthyl,
R₂=linear or branched C₁ to C₁₆ alkyl,
R₃═H, benzyl, linear or branched C₁ to C₁₈ alkyl,
n=1 to 200,
m=0 to 80,
where the alkylene oxide units may be arranged randomly or in blocks in any order.

Preferred nonionic surfactants are branched or unbranched C₈ to C₁₅ alkyl ethoxylates having 3 to 20 ethylene oxide units.

Preferred nonionic surfactants are branched or unbranched C₈ to C₁₅ alkyl ethoxylates having 3 to 20 ethylene oxide units.

The nonionic surfactants may be PO/EO block copolymers.

The nonionic surfactants may be alkylpolyglucosides or mixtures thereof, based on C₅ sugars or C₆ sugars, and preferably of the general formula (IIa) or (IIb)

R₁O(R₂O)_{b}(Z)ₐ (IIa)

R₁O(Z)ₐ(R₂O)_{b}H (IIb)

where
R₁=linear or branched C₄ to C₃₀ alkyl,
R₂═C₂ to C₄ alkylene,
Z=independently at each occurrence a sugar residue, preferably glucose or xylose,
b=0 to 12,
a=1 to 15, including the possibility of fractional numbers.

In preferred alkylpolyglycosides, R₁ is a linear or branched C₈ to C₁₆ alkyl radical, b=0, and a=1.1 to 4.

Suitable cationic surfactants are
quaternary surfactants, such as quaternary ammonium compounds having one or two hydrophobic groups, cetyltrimethylammonium bromide, soaps, or ammonium salts of long-chain primary amines.

Suitable amphoteric surfactants are alkyl betaines and imidazolines.

Other suitable surfactants are known from McCutcheon's, vol. 1: Emulsifiers & Detergents, McCutcheon's Directories, Glen Rock, USA, 2008 (International Ed. or North American Ed.).

The solutions are composed of solvents and the surface-active substance. Examples of suitable solvents include alcohols, glycols, organic solvents or water, preferably methanol, ethanol or water, more preferably water.

In another preferred embodiment, the surface-active substance (e.g., the surfactant) may be applied together with the curative primer in proportions by mass of 0.001:1 to 1:1, preferably of 0.005:1 to 0.5:1, more preferably 0.01:1 to 0.02:1, separately or mixed, to the surface of the wood-based material.

The surface-active substances may be applied by usual techniques such as rolling, spraying, knifecoating, spreading, preferably rolling or spraying, more preferably spraying. In this operation the temperatures are 10 to 50° C., preferably 15 to 40° C., more preferably 20 to 25° C.

Wood-based materials, particularly in the form of boards, consist of edges and faces. In this invention the faces are referred to as surfaces.

The wood-based materials coated in accordance with the invention are suitable for use as decorative wood-based material boards, more particularly for the production of furniture boards.

### EXAMPLES

### Examples 1 to 8

Commercial unsanded 19 mm P2 chipboard (emission class E1) [examples 1 to 8] were used.

Surfactants:
SDS: Sulfopon® 12 G=C₁₂ alkyl sulfate, Na salt, anionic surfactant
KP933: Kauropal® 933=isononyl-PO/EO-OH, nonionic surfactant

The results can be seen in table 1.

### Comparative Examples C1 and C2

Commercial unsanded 19 mm P2 chipboard (emission class E1) were used.

The results can be seen in table 1.

Testing of coatability by droplet holdout time:

As a measure of the coatability, the holdout time of a water droplet or the curative droplet was employed: Using a pipette, a liquid droplet of defined volume was applied to the surface of the wood-based material and a determination was made of the time taken for the liquid to be taken completely into the WBM surface. The longer the droplet holdout time, the poorer the coatability.

Coating materials:

The wood-based material boards were coated as follows with decorative papers.
MFC: coating of the wood-based material boards with melamine-resin-impregnated decorative papers.
Foil: coating of the wood-based material boards with curative primer, surface glue and urea-resin-impregnated decorative papers.

Materials testing of the coating:
CCT=cross-cut test:
Using a cutter blade, a diamond-shape pattern of cuts was produced on the surface (spacing of the individual cuts about 1 to 2 mm). In the case of poor adhesion, the surface coating flakes off, particularly in the acute-angle corners of the diamonds. The result was evaluated according to a simplified school-grade system: 1—no flakes, 2—a few flakes, 3—many flakes
T=“tearing”:
After coating had been carried out, an overhang of paper was pulled vertically to the surface of the chipboard. From the nature of the tear, a conclusion was drawn about the quality of the adhesion (evaluated: good=tear took place directly at the edge; moderate=paper tears off partly at the edge and is partly detached again from the board; poor: foil is easily detached from the surface).

TABLE 1

| | | | | Droplet | | | |
|---|---|---|---|---|---|---|---|
| | | | | holdout | | | |
| Example | Board | | Amount of | time | Coating | Materials | Adhesion |
| No. | type | Surfactant | surfactant | [min] | material | testing | value |
| 1 | Chip | KP933 | 0.5 g/m² | 24 | MFC | CCT | 1 |
| 2 | Chip | KP933 | 0.5 g/m² | 24 | Foil | T | good |
| 3 | Chip | KP933 | 1 g/m² | 17 | MFC | CCT | 1 |
| 4 | Chip | KP933 | 1 g/m² | 17 | Foil | T | good |
| 5 | Chip | SDS | 1 g/m² | 9 | MFC | CCT | 1 |
| 6 | Chip | SDS | 1 g/m² | 9 | Foil | T | good |
| 7 | Chip | SDS | 2 g/m² | 1 | MFC | CCT | 1-2 |
| 8 | Chip | SDS | 2 g/m² | 1 | Foil | T | moderate |
| C1 | Chip | — | — | >60 | MFC | T | 2-3 |
| C2 | Chip | — | — | >60 | Foil | CCT | poor |

1.-17. (canceled)

18. A method for coating wood-based materials, which comprises treating the surface of a wood-based material with 0.05 to 50 g/m² of a surface-active substance, placing solutions composed of solvents and the surface-active substance, and coating the wood-based materials with decorative papers.

19. The method for coating wood-based materials according to claim 18, wherein the surface of the wood-based material is treated with a surface-active substance, without partial abrading of the wood-based material.

20. The method for coating wood-based materials according to claim 18, wherein the surface of the wood-based material is treated with 0.1 to 20 g/m² of the surface-active substance.

21. The method for coating wood-based materials according to claim 18, wherein the surface of the wood-based material is treated with 0.3 to 10 g/m² of the surface-active substance.

22. The method for coating wood-based materials according to claim 18, wherein the surface-active substance is used as a 0.1 to 60 wt % solution.

23. The method for coating wood-based materials according to claim 18, wherein the surface-active substance is used as a 0.5 to 50 wt % solution.

24. The method for coating wood-based materials according to claim 18, wherein the surface-active substance is used as a 1 to 40 wt % solution.

25. The method for coating wood-based materials according to claim 18, wherein the surface-active substance is used as a 2.5 to 30 wt % solution.

26. The method for coating wood-based materials according to claim 18, wherein the surface-active substance is used 1 to 40 wt % solution.

27. The method for coating wood-based materials according to claim 18, wherein the surface-active substance is a surfactant.

28. The method for coating wood-based materials according to claim 27, wherein said surfactant used comprises anionic, cationic, nonionic, amphoteric surfactants or mixtures thereof.

29. The method for coating wood-based materials according to claim 28, wherein said anionic surfactants used comprise alkali metal, alkaline earth metal or ammonium sulfates, sulfates of branched or unbranched fatty alcohols or oxo-process alcohols, branched or unbranched fatty alcohol alkoxylates or oxo-process alcohol alkoxylates, fatty alcohol ether sulfates having branched or unbranched C₈-C₂₀ alkyl chains and 2 to 50 ethylene oxide (EO) units, sulfates of fatty acids and oils, ethoxylated alkylphenol sulfates, alcohol sulfates, sulfates of ethoxylated alcohols or fatty acid esters, sulfates of naphthyl alcohol or ethoxylated naphthyl alcohol, sulfates of arylalkyl alcohols or arylalkyl ethoxylates, alkali metal, alkaline earth metal or ammonium sulfonates, sulfonates of fatty acids and oils, sulfonates of ethoxylated alkylphenols, sulfonates of alkoxylated arylphenols, naphthalenesulfonate condensates, dodecyl- and tridecylbenzenesulfonates, naphthalene- and sikylnaphthalenesulfonates or sulfosuccinates, sulfonates of branched or unbranched fatty alcohols or oxo-process alcohols, sulfonates of branched or unbranched fatty alcohol alkoxylates or oxo-process alcohol alkoxylates, sulfonates of fatty acids and oils, ethoxylated alkylphenol sulfonates, alcohol sulfonates, sulfonates of ethoxylated alcohols or fatty acid esters, sulfonates of naphthyl alcohol or ethoxylated naphthyl alcohol, sulfonates of arylalkyl alcohols or arylalkyl ethoxylates, phosphates of branched or unbranched fatty alcohols or oxo-process alcohols, phosphates of branched or unbranched fatty alcohol alkoxylates or oxo-process alcohol alkoxylates, phosphates of fatty acids and oils, ethoxylated alkylphenol phosphates, alcohol phosphates, phosphates of ethoxylated alcohols or fatty acid esters, phosphates of naphthyl alcohol or ethoxylated naphthyl alcohol, phosphates of arylalkyl alcohols or arylalkyl ethoxylates, or mixtures thereof.

30. The method for coating wood-based materials according to claim 29, wherein said alkali metal, alkaline earth metal or ammonium sulfates used comprise such as ammonium sulfate, lithium sulfate, sodium sulfate, potassium sulfate, calcium sulfate, magnesium sulfate, strontium sulfate, lithium hydrogensulfate, sodium hydrogensulfate, potassium hydrogensulfate, calcium hydrogensulfate, magnesium hydrogensulfate, strontium hydrogensulfate, preferably sodium sulfate, potassium sulfate, calcium sulfate, magnesium sulfate, sodium hydrogensulfate, potassium hydrogensulfate, calcium hydrogensulfate, magnesium hydrogensulfate, preferably sodium sulfate, potassium sulfate, calcium sulfate and magnesium sulfate, more particularly sodium sulfate and ammonium sulfate, or mixtures thereof.

31. The method for coating wood-based materials according to claim 28, wherein said surfactant used comprises C₁₂ alkyl sulfate, Na salt.

32. The method for coating wood-based materials according to claim 28, wherein said surfactant used comprises isononyl-PO/EO-OH.

33. A coated wood-based material obtained by the process according to claim 18.

34. A decorative wood-based material board comprising the coated wood-based material according to claim 33.
